(19) United States
(12) Patent Application Publication
(10) Pub. No.: US 2012/0191492 A1
(43) Pub. Date: Jul. 26, 2012

(54) Multi-City Criteria Correlation and Cost Query Apparatus

(76) Inventors: Farzad Diba, Mequon, WI (US); Malek Abdel-Fattah, Milwaukee, WI (US)

(21) Appl. No.: 13/038,265

(22) Filed: Mar. 1, 2011

Related U.S. Application Data
(60) Provisional application No. 61/435,693, filed on Jan. 24, 2011.

(51) Int. Cl. G06Q 50/00

(52) U.S. Cl. 705/6

(57) ABSTRACT

A multi-city criteria correlation and cost query (MCCQ) apparatus generates potential travel destination suggestions. The MCCQ apparatus is configured with a user interface adapted to receive source and destination criteria from a user which is processed using a multi-criteria correlation processor and comparing the destination criteria to information about destinations in a city database. City data record objects and city pair objects are formed for each identified destination alternative and transmitted to an internal or third party supplier of travel cost or other pertinent travel data. City response record objects or city pair report objects are generated corresponding to the data attributes of each city data record object or city pair object and are stored in a temporary aggregation database. In various embodiments results are sorted and/or filtered to generate a multi-destination comparison report including cost or other data which may be displayed as a physical document or on a user interface component.

### CROSS-REFERENCE TO RELATED APPLICATIONS

This application claims priority to U.S. Provisional Application No. 61/435,693 filed on Jan. 24, 2011.

### FIELD OF INVENTION

The present invention relates to computer hardware configured to identify travel destinations using a multi-criteria correlation processor to generate city pair objects and produce a quasi-unique multi-destination comparison report.

### BRIEF DESCRIPTION OF THE DRAWINGS

FIG. 1 illustrates an exemplary embodiment of a multi-city criteria correlation and cost query (MCCQ) apparatus which generates simultaneous city data record objects used to produce a multi-destination comparison report.

FIG. 2 is an exemplary embodiment of an MCCQ apparatus which includes a city pair processor and generates city pair objects to query rate supplier databases.

FIG. 3a is an exemplary embodiment of a user interface for an MCCQ apparatus which is configured to receive user input.

FIG. 3b is an exemplary embodiment of a user interface for an MCCQ apparatus which is configured to display a quasi-unique multi-destination comparison report.

FIG. 4 illustrates an exemplary embodiment of an MCCQ apparatus in which multiple city information databases are dynamically updated.

FIG. 5 illustrates an exemplary embodiment of an MCCQ apparatus which further includes a sort and filter processor which narrows search results returned to a user based on administrator specified criteria.

FIG. 6 illustrates an exemplary embodiment of a method which allows a user to create and display one or more multi-destination comparison reports.

FIG. 7 illustrates an exemplary embodiment of an MCCQ apparatus which includes promotional information processing capability.

FIG. 8 is an exemplary embodiment of an MCCQ apparatus which provides alternative suggestions if there are no travel destinations which match destination criteria entered by a user.

FIG. 9 is an exemplary embodiment of an MCCQ apparatus which compares destination criteria and travel cost components for a single destination with multiple origin locations.

### TERMINOLOGY

A used herein, the term “administrator” refers to any person or apparatus capable of altering the functionality of an MCCQ.

As used herein, the term “administrator specified criteria” refers to criteria which are used to modify results provided to a user. For example, administrator specified criteria may include, but is not limited to, weather conditions, precipitation, severe adverse weather, weather-related factors, such as a UV-index or pollution levels, natural disasters, political unrest, protests, war, security alerts, epidemics, fuel shortages and other criteria which an administrator may use to limit search results returned to a user.

As used herein, the term “backend processor” refers to a computer processing component which performs an operation that is not seen by a user.

As used herein, the term “city data attribute” refers to any information stored in a city information database which may be used to match a travel destination to destination criteria selected by a user.

As used herein, the term “city information database” refers to any database, list, document or record pertaining to information about, or containing city data attributes for, any city, town, municipality, village, neighborhood, district, territory or other geographically identifiable location that may be a travel destination. A city information database may include information and city data attributes for more than one city, town, municipality, village, neighborhood, district, territory or other geographically identifiable location that may be a travel destination.

As used herein, the term “city pair” refers to a single departure city and a single destination city.

As used herein, the term “database” includes, but is not limited to, physical memory, temporary or permanent storage of data, object and record attributes, lists, data structures, physical storage components, virtual storage components and any other manner of storing data known in the art used to perform a function.

As used herein, the terms “destination criterion” and “destination criteria” include, but are not limited to, budget, cost, geographic region, ethnicity, religion, historic temperature, projected temperature, weather conditions, sport activities, sport events, customer demographics, market demographics, business climate, business related characteristics, sales climate, manufacturing capabilities, medical capabilities, family oriented activities, cultural activities, music activities, music events, cultural events, medical tourism, food types, dietary restrictions, adult entertainment activities, culinary characteristics, alcohol production and consumption characteristics, rehabilitation services, substance abuse services, weight loss services, education services, educational characteristics, scholastic events, scholastic capabilities, festival events, hobby related activities, hobby related events, pet related criteria, animal specific criterion, eco-tourism, cultural interests, cultural events, cultural activities, exercise events, exercise activities, fetishes, air quality, investment potential, favorable legal environments, popular film and film festival destinations, film events, theater events, musical events, popular film locations, space destinations, destinations in space, cruise destinations, water specific activities, air shows, forest and nature destinations, camping destinations, conferences, conference events, personal retreats, corporate retreats, religious retreats, retreats, weddings, wedding locations, ecological tourism destinations, archeological destinations, crime destinations, beverage centric destinations, industrial destinations, commodities, language, male to female ratio, safety, political alignment and human rights record.

As used herein, the term “distributed” means that physical and logical components, data recipients, and/or participants may be in a single location or in multiple locations.

As used herein, the term “filter” refers to any function or processing components which limit travel search results displayed to a user.

As used herein, the term “invoke” means to call a function.

As used herein, the term “multi-city criteria correlation and cost query apparatus” or “MCCQ” refers to an apparatus which generates simultaneous city pair report objects used to produce a multi-destination comparison report.

As used herein, the term “multi-criteria correlation” refers to any algorithm or process which successively diminishes the range of results by recursively or iteratively comparing them to one or more user defined criteria.

As used herein, the term “multi-destination comparison report” refers to a physical or virtual document or hardware configured to display at least one destination meeting one or more cost and/or other user specified criteria. A multi-destination comparison report may display data which compares multiple travel destinations based on at least one destination criterion. A multi-destination comparison report may be quasi-unique.

As used herein, the term “network connection” refers to any software or hardware that allows two or more computers or devices to communicate with one another.

As used herein, the term “object” refers to a data structure which includes data attributes and/or functions.

As used herein, the term “physical storage component” refers to any data storage device, including, but not limited to, computer memory, disks, internal or external hard drives, flash drives, and other memory devices.

As used herein, the term “processor” refers to any hardware component configured with software to perform a calculation, function or operation. As used herein, a processor may also include a function that resides on a physical device.

As used herein, the term “quasi-unique” means having the appearance of being unique or customized for a user.

As used herein, the term “rate plan tracking processor” refers to one or more devices configured individually or in combination to track payment and the amount received as payment for data or services.

As used herein, the term “real time” means during a single user session, event, or other time period defined by a user, participant, data recipient, or administrator.

As used herein, the term “region” refers to a common geographical area shared by one or more destination cities.

As used herein, the term “revenue processing component” refers to any software or hardware component utilized for processing payments or credits or for validating user privileges associated with the exchange of financial data.

As used herein, the term “sort and filter processor” refers to any software or hardware component utilized for sorting or filtering based on destination criteria, ranked destination criteria, administrator specified criteria, budget, or other user or administrator defined criteria.

As used herein, the term “third party” refers to any supplier of travel data or services that may be accessed or utilized by an MCCQ apparatus.

As used herein, the term “travel cost component” refers to any aspect of travel which may be varied that affects the cost of travel, including, but not limited to, the number and demographic of travelers, budget, transportation arrangements and costs, hotel costs, desired activities, desired climates, and desired regional locations.

As used herein, the term “user query record object” refers to a record or object that contains one or more data attributes pertaining to at least one user search preference.

### BACKGROUND

In excess of 50 million customers search for travel accommodations and services each month. According to studies undertaken by Forrester Research, travel bookings are the single largest component and fastest growing segment of e-commerce. In 2010, more than 40% of all e-commerce transactions were for online travel.

Travel consumers are becoming increasingly sophisticated and demand technologies that expand the scope and breadth of results they can achieve in real time and the amount of information that can be obtained in a single query session. Traditional travel site search technologies have had their markets quickly eclipsed by the advent of “meta search” engines which offer the convenience of aggregating information from several sites and suppliers thereby reducing the number of necessary searches.

Meta search engine technology was initially developed in response to consumer surveys in which respondents indicated that they felt that no single travel search engine was able to provide all airfares and the need for technologies that could increase travel search information available to consumers.

Research indicated that consumers were required to perform multiple site searches to achieve desired results. Meta search technology was developed to reduce the number of queries required to produce complete online travel search results.

Advanced travel search technology known in the art includes several U.S. patents issued to Kayak Software Corporation (“Kayak”), including U.S. Pat. Nos. 7,483,883, 7,627,606, 7,668,809, 7,668,811 and 7,774,331 and U.S. application Ser. Nos. 11/951,098 and 12/819,997. These issued patents and pending application are directed at aggregating search results from multiple travel suppliers to obtain the lowest cost of airfare or accommodations at a particular destination. Kayak's U.S. application Ser. No. 11/951,098 discloses a method and system for efficiently performing travel reservation queries and presenting the search results from multiple sites to a user who is searching for rates for a particular destination.

Kayak builds on travel search engines known in the art, which search airfare, hotel and other services provided to the sites directly. One such travel site known in the art is Travelocity.com LP (“Travelocity”), which is the assignee of U.S. Pat. No. 7,890,652. Kayak's technology aggregates the results found on sites like Travelocity and is highly efficient for a user that knows his or her destination.

Travelocity's U.S. patent application Ser. No. 12/037,394 allows users to enter destination queries, and the system generates a concise listing of low-priced travel products and allows a user to specify a “travel theme” selecting from different travel packages for a specific destination.

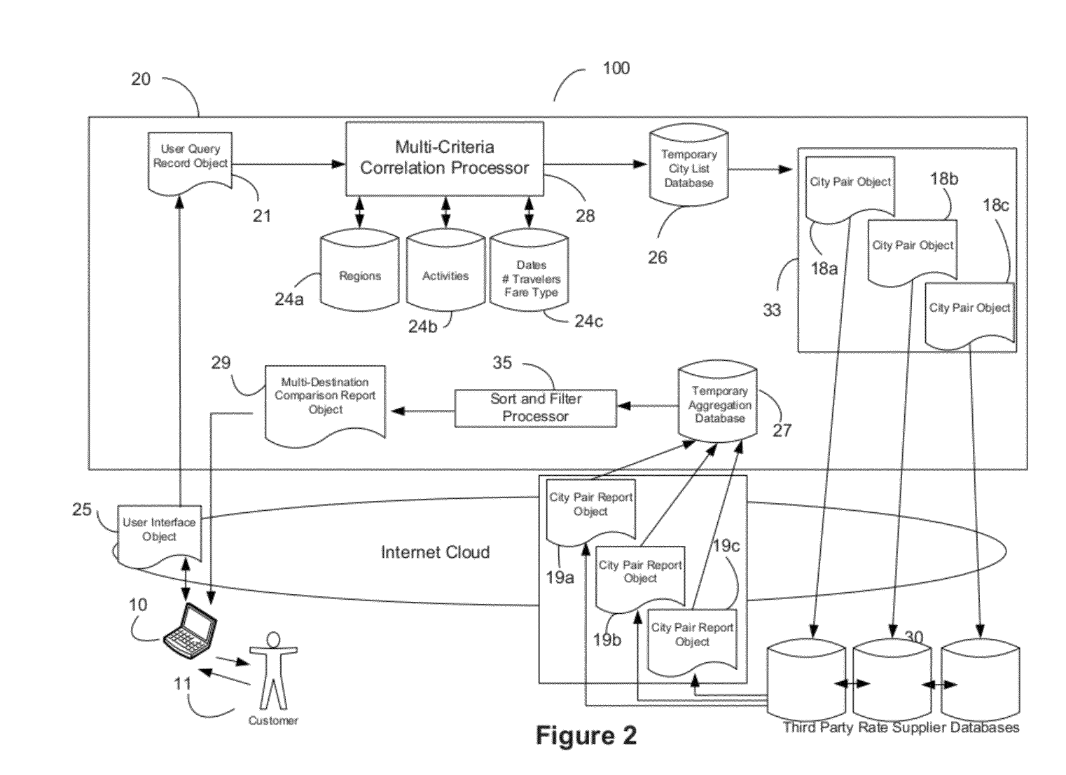

Travelocity's U.S. Pat. No. 7,395,220 (the '220 patent) teaches a technology which offers users the ability to further specify preferences for travel packages and see vacation specials in different categories, in particular travel packages leaving from their departure cities. Consumers indicate the category of advertised specials they want to see. In the '220, patent, an exemplary screen shot (FIG. 2C) displays categories such as “popular,” “romantic,” and “rest and relax” into which various vacation packages are categorized.

The '220 patent is of interest in the prior art because it allows users to shop for vacations without specifying a destination. However, the technology is limited to the indexing of advertised specials and vacation packages supplied by travel service suppliers. This technology is primarily directed toward the liquidation of distressed inventory ('220 patent, col.5, lines 33-38).

Using Kayak, a user enters a desired destination, and the Meta Search Engine aggregates results from other sites then redirects the visitor to one of these sites for reservations. Kayak.com derives revenue from pay per click advertising, when the consumer clicks through to one of the compared websites (for example, when the consumer is redirected to the Orbitz or Expedia website).

Meta Search technologies are commercially successful because they offer the user the advantage of not having to use multiple search engines separately and are able to display a comprehensive view of travel listings and pricing information available online. These sites offer sorting, filtering, and navigation tools to sift through travel options quickly and easily.

Meta search technologies quickly captured seventy percent (70%) of the online travel market within a year after their introduction.

When used in combination with existing technologies, users can quickly compare the costs of visiting a particular destination and identify travel specials and inventory liquidations during a specified time frame.

However, while Meta Search engines send user requests to several search engines and/or databases and aggregate the results for a single destination, there is no technology known in the art which assists a user in efficiently planning an itinerary when his or her destination is not known.

Meta Search technology know in the art are also limited with respect to many everyday search needs. Meta Search engines are limited to performing searches for which a user can identify a single, specific source and destination.

Meta Systems are designed and predicated on the assumption that a user knows his or her travel destination at the time a search is initiated. Current search tools are directed only at the problem of obtaining cost comparison data for travelers when a destination is known or in identifying liquidation inventories for “last minute” specials when a destination is not specified.

There are many examples of everyday travel issues that current travel search technologies known in the art do not address. For example, a traveler might want to select a vacation destination in the Carribean and may be flexible in the choice of destination based on price. A sales person might wish to make targeted in-person sales calls to gauge the customer response to a product line and may want to select the most economical destinations to visit on a limited travel budget. A business may want to send employees to a conference or retreat and may need to compare the costs of travel and accommodations of holding the event at several destinations. Wedding planners may want to select a city for a wedding based on the comparative travel costs for out-of-state family members.

Currently, there is no travel search technology known in the art which allows a user to initiate a search to compare travel costs if the user does not specify a destination.

A user who desires to compare travel costs among several destinations is required to initiate a separate search on a travel site for each prospective destination. The user must independently track the results of each search, without the benefit of any technology which stores or displays comparative cost data for each destination.

More importantly, a user must self-identify all prospective destinations that may meet the criteria for his or her vacation, business trip or other event. If a user is not aware of a particular location based on personal knowledge and experience, the user will not initiate a search for that location, and that location will not be considered as an alternative. For example, a user may not be aware that Huatalco is an alternative to Cancun and should be searched. Current search technologies known in the art do not allow a user to identify multiple and/or unknown destinations which meet his or her travel criteria.

### SUMMARY OF THE INVENTION

The present invention is a multi-city criteria correlation and cost query apparatus with a user interface adapted to receive source and destination criteria from a user which is processed using a multi-criteria correlation processor and comparing the destination criteria to information about destinations in a city database. City data record objects and city pair objects are formed for each identified destination alternative and transmitted to an internal or third party supplier of travel cost or other pertinent travel data. City response record objects or city pair report objects are generated corresponding to the data attributes of each city data record object or city pair object and are stored in a temporary aggregation database. In various embodiments results are sorted and/or filtered to generate a multi-destination comparison report including cost or other data which may be displayed as a physical document or on a user interface component.

### DETAILED DESCRIPTION OF INVENTION

For the purpose of promoting an understanding of the present invention, references are made in the text to exemplary embodiments of a method and system for suggesting travel destinations, only some of which are described herein. It should be understood that no limitations on the scope of the invention are intended by describing these exemplary embodiments. One of ordinary skill in the art will readily appreciate that alternate but functionally equivalent structures and processes may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

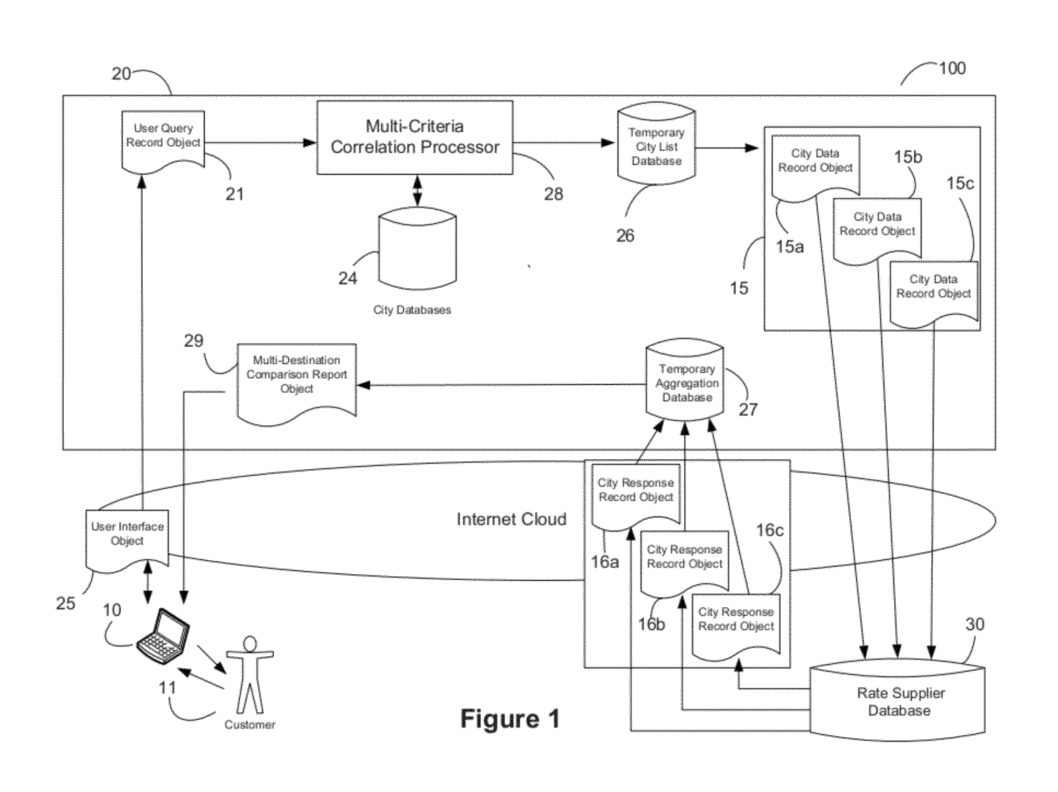

FIG. 1 illustrates an exemplary embodiment of MCCQ apparatus 100. In the embodiment shown, MCCQ apparatus 100 includes multi-city query server 20. Multi-city query server 20 is configured with software to create user interface object 25 which is used to create and update user interface 10. User interface 10 is configured to receive destination criteria (user data attributes) from user 11 relevant to a user's 11 selection of a particular destination criterion. Multi-city query server 20 is configured with software to create user query record object 21 based on user-input destination criteria. User query record object 21 is transmitted to multi-criteria correlation processor 28, which correlates the user data attributes with known attributes of cities (city data attributes) stored in city information database 24. City information database 24 contains city data attributes for all known or all relevant cities which may be a travel destination, and city data attributes for relevant cities are correlated to user data attributes in user query record object 21 using multi-criteria correlation processor 28.

In the embodiment shown, multi-city query server 20 includes a single city information database 24, but in further exemplary embodiments may include more than one city information database 24. In the embodiment shown, multi-city query server 20 is shown as a single database, but in various embodiments may be multiple local or geographically dispersed databases or data sources containing city data attributes. In various embodiments, user query record object 21 may contain any destination criteria known in the art which may be capable of identifying a city data attribute. In various embodiments, user query record object 21 may also include date, time, price, budget or other information which may be used to form relevant travel search queries.

In the embodiment shown, multi-criteria correlation processor 28 is capable of executing a recursive search algorithm which performs successive searches using destination criteria to create a quasi-unique city list based on a unique combination of destination criteria specified by user 11, which determines a unique search algorithm and the number of iterations and levels of search performed using the algorithm. In various embodiments, user 11 may also specify levels of priority for various criteria to further customize the search algorithm.

In further exemplary embodiments, a search may be performed by specifying subcategories or second level criteria. For example, a user may specify a region such as the Caribbean, and specify a second tier criterion, such as the West Indies or a particular coast line, thus further modifying the quasi-unique search algorithm.

Other exemplary embodiments may include simple criteria searches such as “vacation budget,” travel dates or region. In various embodiments, a user may know only available dates and budget and may be successively prompted for other destination criteria after each iteration of multi-criteria correlation processor 28.

In the embodiment shown, the list of relevant cities (based upon the recursive search using one or more user data attributes) is stored in temporary city list database 26 and processed by city record object processor 15 to create matched city data record objects 15a, 15b, and 15c. In the embodiment shown, temporary city list database 26 is a physical storage unit that operates as a temporary database, but in other embodiments may be any functionally equivalent means known in the art for storing a temporary database.

Matched city data record objects 15a, 15b, and 15c are used to query third party rate supplier database 30 containing rate and cost information for a travel cost component of a travel itinerary. In the embodiment shown, city data record objects 15a, 15b and 15c query a single rate supplier database 30; although more than one third party rate supplier database 30 may be queried using city data record objects 15a, 15b and 15c. Information obtained from this query is stored in city response record objects 16a, 16b and 16c, which are aggregated in temporary aggregation database 27. Multi-city query server 20 is configured with software to create multi-destination comparison report object 29 based on city response record objects 16a, 16b and 16c, which are further processed by multi-city query server 20 for display on updated user interface 10.

FIG. 2 is an exemplary embodiment of MCCQ apparatus 100 which includes multiple city information databases 24a, 24b and 24c and city pair processor 33. After multi-city query server 20 forms user query record object 21, multi-criteria correlation processor 28 correlates the user data attributes with known attributes of cities (city data attributes) stored in city information databases 24a, 24b and 24c, which in the exemplary embodiment shown contain city data attributes pertaining to regions, available activities and travel cost components. City data attributes contained in city information databases 24a, 24b and 24c are correlated to user data attributes in user query record object 21 using multi-criteria correlation processor 28.

In the embodiment shown, multi-criteria correlation processor 28 develops a list of relevant cities based off user data attributes, and the list of relevant cities is stored in temporary city list database 26. City pair processor 33 generates a plurality of potential city pairs matching the travel component input from user 11 and creates multiple city pair objects 18a, 18b, and 18c, each of which contains data attributes identifying an origin city and potential destination city. City pair processor 33 correlates the information from multi-city server 20 with the city pairs and, using at least one algorithm, limits the city pairs to only those matching the travel component input from user 11. City pair objects 18a, 18b and 18c are used to query third party rate supplier database 30 (e.g. Google) for travel information, such as airfare, bus, train or driving costs. In various embodiments, city pair objects 18a, 18b, and 18c and third party rate supplier databases 30 may contain pricing, time and other relevant information pertaining to city pair objects 18a, 18b, and 18c generated by city pair processor 33.

In the exemplary embodiment shown, third party rate supplier database 30 may be a database that is a component on multi-city query server 20 or may be third party travel information or a third party travel information supplier known in the art such as Sabre Inc, Google, or ITA. Data obtained from third party rate supplier database 30 may include airfare information, hotel rates or any other information relevant to travel cost information or destination criteria.

In the embodiment shown, travel cost information is associated with each city pair object 18a, 18b and 18c is used to generate multiple city pair report objects 19a, 19b, and 19c containing travel information from third party travel rate supplier databases 30, which are transmitted to temporary aggregation database 27 housed on multi-city query server 20. City pair report objects 19a, 19b, and 19c are sorted and filtered by sort and filter processor 35 to be displayed in a multi-destination comparison report. Sort and filter processor 35 sorts and filters city pair report objects 19a, 19b, and 19c by cost or any other destination criteria, travel cost component or ranking specified by user 11 or as programmed and generates multi-destination comparison report object 29. Multi-destination comparison report object 29 is processed and configured by multi-city query server 20 to be displayed as a multi-destination comparison report on updated user interface 10.

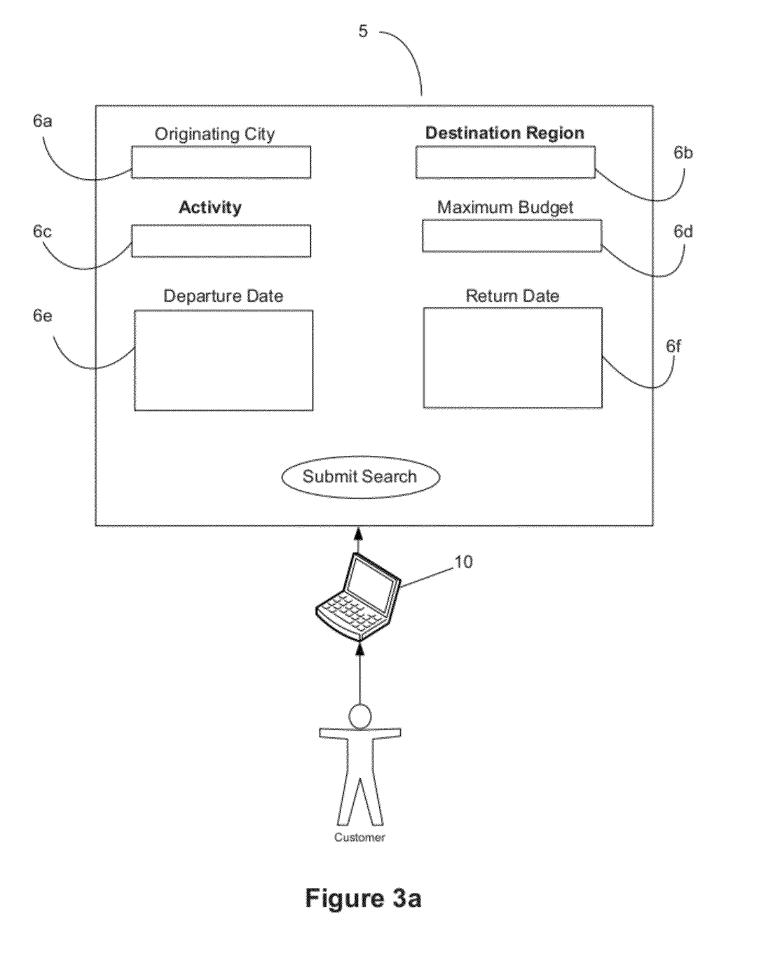

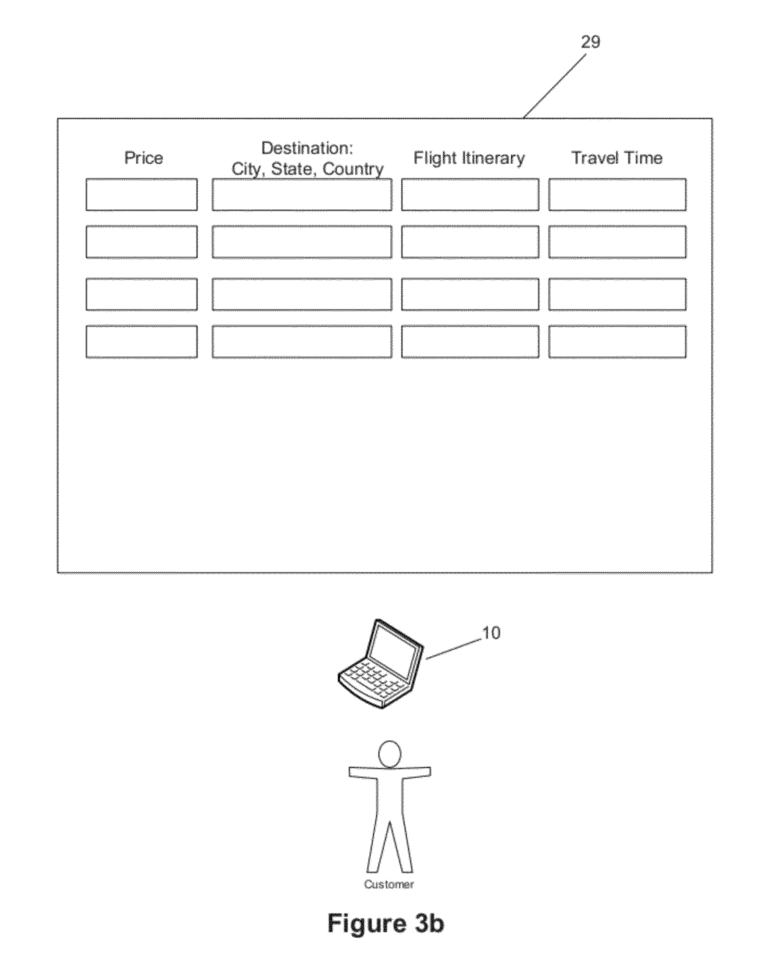

FIG. 3a is an exemplary embodiment of user interface 10 for MCCQ apparatus 100 which is configured to display user input screen 5. User input screen 5 contains prompts 6a and 6b for a user to enter an originating city and a potential destination. Prompt 6c allows a user to enter destination criteria relating to a user's preferred activities, and prompt 6d allows a user to enter destination criteria pertaining to a budget. Users are also requested to provide a departure date and a return date using prompts 6e and 6f. In further exemplary embodiments, user interface 10 may be differently arranged or configured with drop down menus, selection buttons, boxes or icons or any other object or format to allow a user to input information pertaining to origination and destination locations and other destination criteria. In still further exemplary embodiments, user interface 10 may be adapted to receive user input regarding destination criteria using a plurality of user input screens 5.

FIG. 3b is an exemplary embodiment of user interface 10 for an MCCQ system which is configured to display a quasi-unique multi-destination comparison report 29. In the exemplary embodiment shown, multi-destination comparison report displays the price, destination, flight information and expected travel time for four potential travel destinations. In further exemplary embodiments, multi-destination comparison report may contain additional or alternative information pertaining to the specific destination criteria, travel cost components and other limiting information specified by a user. A user may also be able to arrange destinations displayed on multi-destination comparison report 29 based on desired or ranked destination criteria or travel cost components. In still further exemplary embodiments, multi-destination comparison report may display more or fewer options depending on the number of city pairs MCCQ apparatus determines matches the destination criteria and other attributes entered by a user.

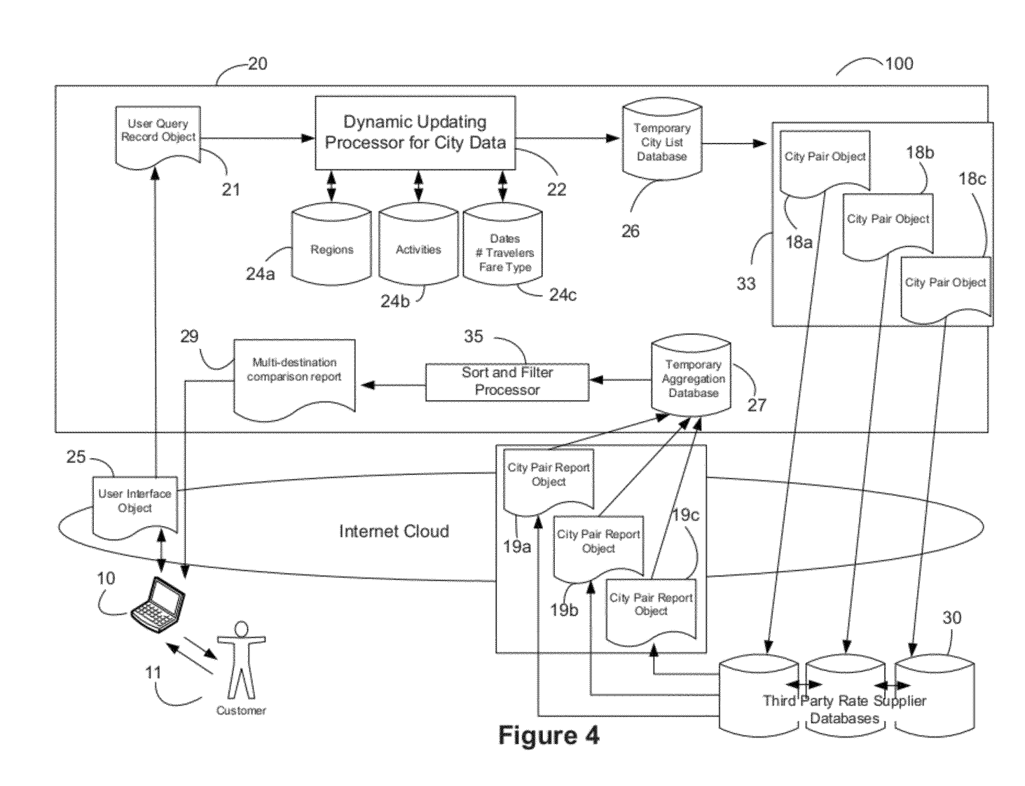

FIG. 4 illustrates an exemplary embodiment of MCCQ apparatus 100 in which multiple city information databases 24a, 24b and 24c are dynamically updated. User 11 enters destination criteria using user interface 10. Multi-city query server 20 is configured with software to create user query record object 21 using the destination criteria entered by user. In the embodiment shown, multi-city query server 20 includes city information databases 24a, 24b and 24c. These databases contain information pertaining to regional classification of travel destinations, activities available near travel destinations and types of transportation available to travel destinations. In further exemplary embodiments, city information databases 24a, 24b and 24c may contain other information for potential travel destinations which may be correlated with destination criteria input by user 11. In other embodiments, multi-city query server 20 may contain additional city information databases pertaining to other destination criteria.

In the exemplary embodiment shown, city information databases 24a, 24b and 24c are dynamically updated using dynamic updating processor for city data 22 to include the most recent information for any city, town, municipality, village, neighborhood, district, territory or other geographically identifiable location that may be a travel destination. For example, city information databases 24a, 24b and 24c may be updated by a national weather service to include historic or average weather conditions. City information databases 24a, 24b and 24c may also be updated by governmental agencies to include most recent demographic statistics or other political information, including, but not limited to, economic conditions, political unrest and other current events which may impact travel. In still further exemplary embodiments, city information databases 24a, 24b and 24c may also be updated by travel organizations, hotel chains, resorts, parks departments, or other groups or organizations to include accurate information pertaining to destination criteria a user may enter to generate a list of potential travel destinations.

Data from databases 24a, 24b and 24c is correlated to destination criteria in user query record object 21 using dynamic updating processor 22. Dynamic updating processor 22 is capable of executing a recursive search algorithm to create a quasi-unique city list which is stored in temporary city list database 26. City pair processor 33 uses the quasi-unique city list to create multiple city pair objects 18a, 18b and 18c matching the destination criteria input from the user. City pair objects 18a, 18b and 18c are used to query third party rate supplier databases 30 containing pricing, time and other relevant information pertaining to the city pairs, and multiple city pair report objects 19a, 19b and 19c containing travel information from the third party travel rate supplier databases are generated. City pair report objects 19a, 19b and 19c are stored in temporary aggregation database 27 housed on multi-city query server 20. City pair report objects 19a, 19b and 19c are then sorted and filtered by sort and filter processor 35, which forms multi-destination comparison report object 29. Multi-city query server 20 is configured with software to display multi-destination comparison report 29 on updated user interface 10.

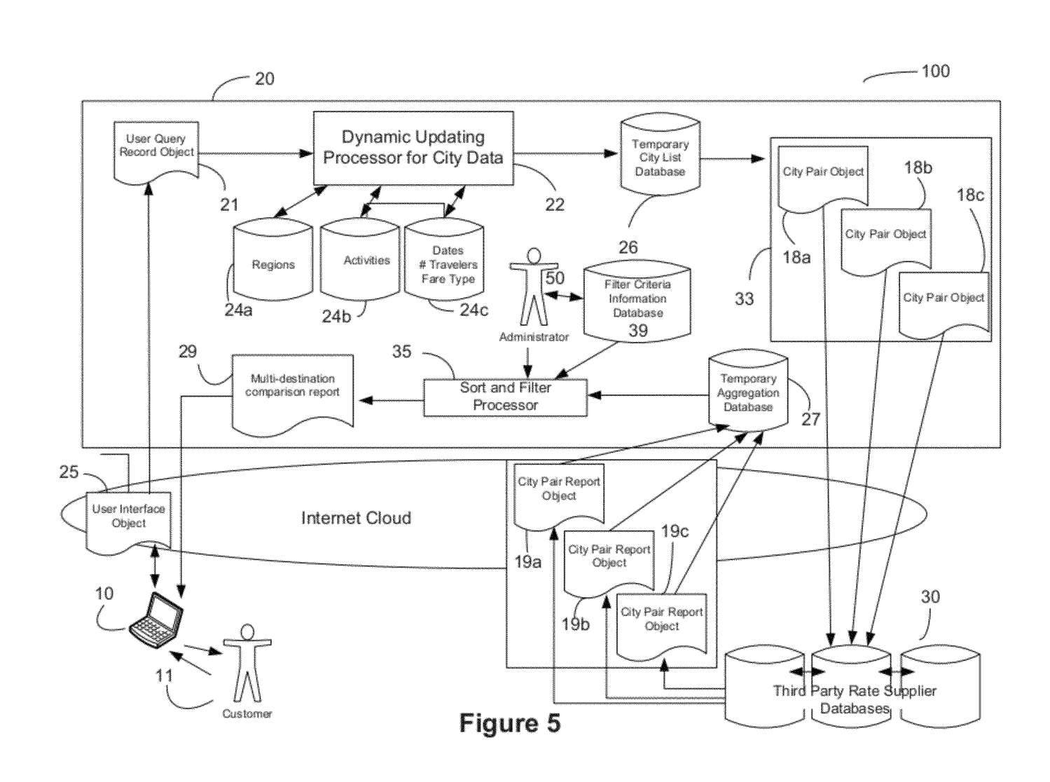

FIG. 5 illustrates an exemplary embodiment of MCCQ system 100 which further includes a sort and filter processor which accepts administrator specified filtering criteria.

In the embodiment shown, sort and filter processor 35 is updated with additional filtering criteria determined by administrator 50. Sort and filter processor 35 applies algorithms and criteria which may narrow potential travel destination suggestion results by characteristics other than those selected by the user (administrator specified criteria). For example, sort and filter processor 35 may narrow potential travel destination suggestion results by selecting a desired temperature range, precipitation (rainfall) or other climatic criteria.

In the embodiment show, sort and filter processor 35 queries filter criteria information database 39 to determine which administrator specified criteria to use. In the embodiment shown, filter criteria information database 39 is a database containing information about acceptable weather and climactic conditions during the travel time frames. Cities which do not fall within acceptable ranges are purged from the report list, or, alternatively, an appropriate designation or warning is included. For example, an administrator may be able to enter a specific temperature range in Fahrenheit or Celsius. In still further exemplary embodiments, a user or administrator may be able to narrow potential travel destination suggestions based on weather conditions other than temperature, including, but not limited to, expected rainfall, humidity, snowfall, and daily temperature range. In yet further exemplary embodiments, a user or administrator may be able to narrow potential travel destination suggestions based on weather-related concerns, such as a UV-index, air quality, hours of daylight and visibility. In even further exemplary embodiments, an administrator may also narrow potential travel destinations based on issues of safety and concern to travelers, including, but not limited to, severe adverse weather conditions, natural disasters, political unrest, security alerts, health alerts, epidemics, war, protests, and fuel shortages.

In the embodiment shown, updated user interface 10 displays the filtered list of regions or cities that match desired administrator specified criteria, and user 11 may narrow the results by using user interface 10 to enter other desired destination criteria. Sort and filter processor 35 generates a refined list of city pairs corresponding to the user's selected criteria.

In the embodiment illustrated in FIG. 5, administrative specified criteria may include, but is not limited to, weather conditions, temperature ranges, weather-related concerns, severe inclement weather, health concerns, natural disasters, security alerts, political unrest, protests, war, epidemics and fuel shortages.

Administrator 50 may enter administrator specified criteria which may or may not alter algorithms used by sort and filter processor 35.

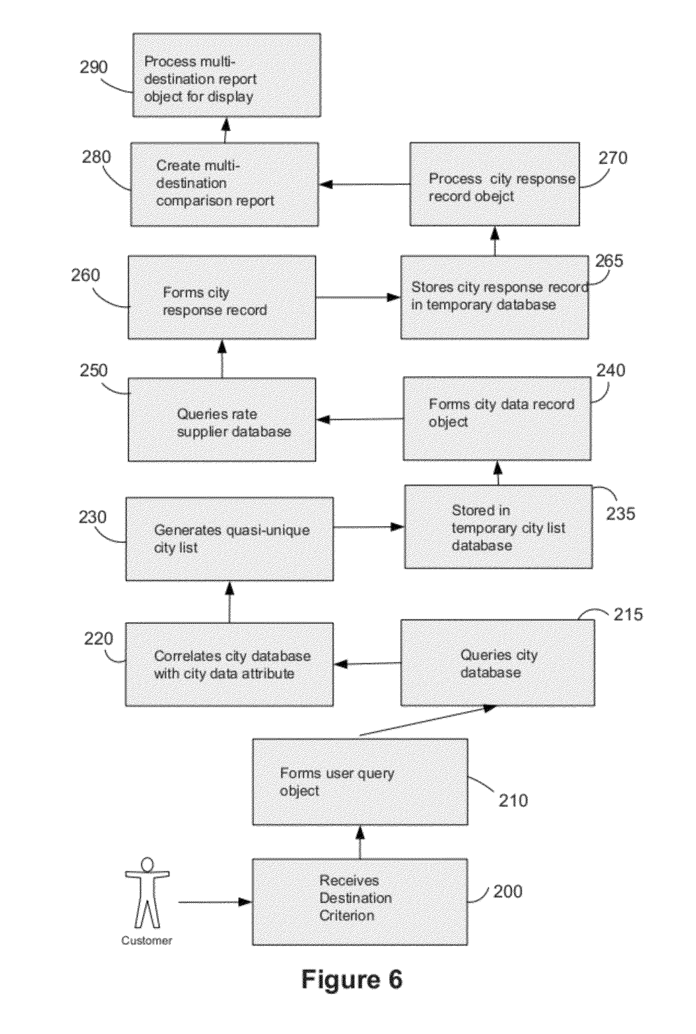

FIG. 6 illustrates an exemplary embodiment of a method which allows MCCQ apparatus 100 to create and display one or more multi-destination comparison reports. In step 200, MCCQ apparatus 100 receives at least one destination criterion from a user. MCCQ apparatus then forms at least one user query record object (step 210) based on the destination criteria entered by the user. The user query record object queries at least one city database (step 215) and is correlated with at least one city data attribute from the city information database using a multi-criteria correlation processor in step 220. The correlated data is then used to generate a quasi-unique city list (step 230) which is stored in a temporary city list database (step 235) and used by city record object processor to form at least one city data record object (step 240). In step 250, the city data record object queries at least one rate supplier database, which may be a third party rate supplier database. At least one resulting city response record object is formed (step 260) and stored in temporary aggregation database (step 265). The city response record object may then be processed with a sort and filter processor (step 270) to create a multi-destination comparison report object (step 280) with potential travel destinations that match destination criteria entered by user. A multi-city query server processes the multi-destination comparison report object for display on a user interface in step 290. In further exemplary embodiments, multi-city query server may be configured with software to directly process a city response record object to a multi-destination comparison report object without a sort and filter processor.

In further exemplary embodiments, a user query record object may be processed to generate at least one city pair object, which queries at least one rate supplier database to generate at least one city pair report object. In still further embodiments, an administrator may alter sorting and filtering criteria used by the sort and filter processor.

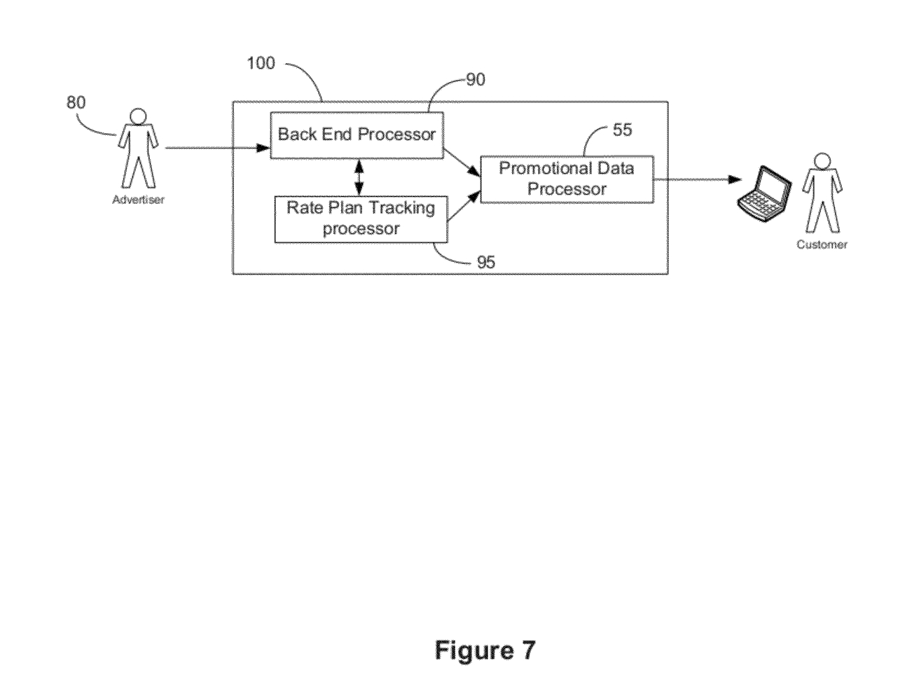

FIG. 7 illustrates an exemplary embodiment of MCCQ apparatus 100 which includes promotional information processing capability. In the embodiment shown, advertiser 80 purchases key words or other triggers which may be used by MCCQ apparatus 100 or entered by a user. Back end processor 90 and rate plan tracking processor 95 processes revenue and payment transactions from advertiser 80 according to a rate plan. Promotional data processor 55 generates a list of travel destination suggestions, messages, alerts or other visual or audible cues to direct a user to a particular destination alternative.

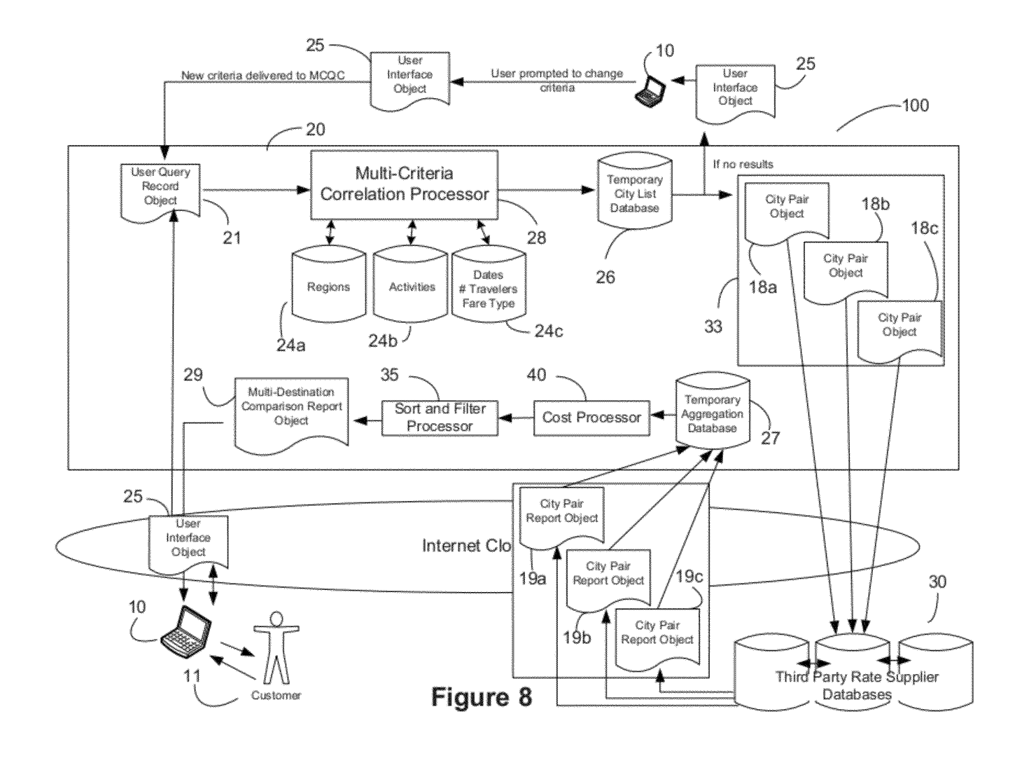

FIG. 8 is an exemplary embodiment of MCCQ apparatus 100 which is further configured to provide alternative suggestions if there are no travel destinations which match destination criteria entered by a user. User 11 enters destination criteria using user interface 10. Multi-city query server 20 generates user query record object 21. Multi-criteria correlation processor 28 correlates information from city information databases 24a, 24b and 24c with destination criteria from user query record object 21 to generate a list of potential destinations to store in temporary city list database 26. If there is at least one resulting city which matches the destination criteria entered by user 11, at least one city pair object 18a, 18b and 18c is generated. If no potential destinations match the destination criteria selected by user 11, multi-city query server 20 updates user interface 10 to inform user 11 that no destinations match the destination criteria and prompt user 11 to alter destination criteria. In further exemplary embodiments, multi-criteria correlation processor 28 is capable of executing a search algorithm which performs successive searches using destination criteria to create a city list which contains potential travel destinations meeting a certain percentage of destination criteria entered, which matches less than 100% of the destination criteria entered by user 11. In further exemplary embodiments, multi-criteria correlation processor 28 may be capable of executing a search algorithm which varies one or more destination criteria to create a city list including at least one potential travel destination.

User interface object 25 directs new criteria entered by user 11 to multi-city query server 20, and a new list of potential travel destinations is created.

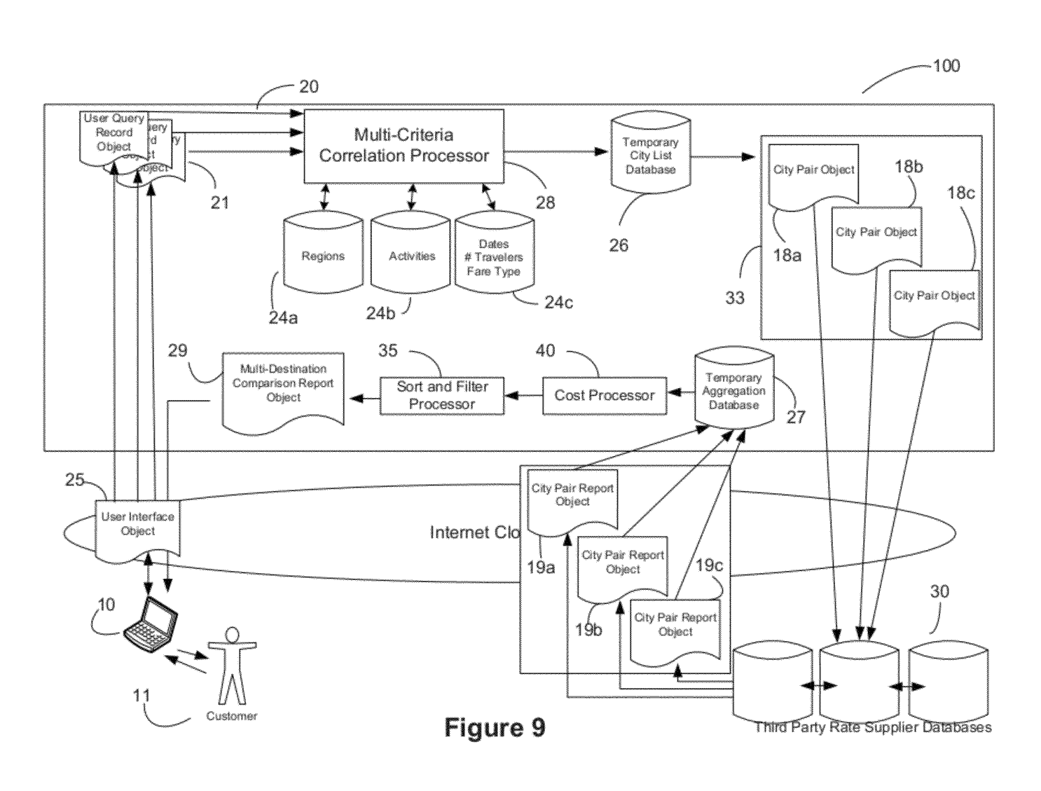

FIG. 9 is an exemplary embodiment of MCCQ apparatus 100 which compares destination criteria and travel cost components for a single destination with multiple origin locations. For example, it may be desirable to enter multiple origination locations when planning a business event. A business event planner may wish to find a travel destination which limits the cost to customers or employees traveling from different locations, but require a location with a suitable business climate and available conference resources.

User 11 enters destination criteria using user interface 10 which includes a plurality of origination locations. Multiple user query record objects 21 are generated as a result. Each user query record object 21 is processed by multi-criteria correlation processor 28, which correlates the user data attributes with known attributes of cities (city data attributes) stored in city information databases 24a, 24b and 24c. Origination information and destination criteria contained in multiple user query record objects 21 determine a unique search algorithm used by multi-criteria correlation processor 28 to produce a temporary list of cities matching destination attributes entered by user 11, including the multiple origination locations, is stored in temporary city list database 26. The search algorithm used by multi-criteria correlation processor 28 is varied to perform different levels of search and numbers of iterations depending on the number origination locations and specific destination criteria entered.

City pair processor 33 generates a plurality of potential city pairs matching the travel component input from user 11 and creates multiple city pair objects 18a, 18b, and 18c, each of which contains data attributes identifying including the multiple origination locations and a destination location. City pair processor 33 correlates the information from multi-city server 20 with the city pairs and, using at least one algorithm, limits the city pairs to only those matching the travel component input from user 11. City pair objects 18a, 18b and 18c are used to query third party rate supplier database 30 and city pair report objects 19a, 19b and 19c are generated containing travel information from third party travel rate supplier databases 30. City pair report objects 19a, 19b and 19c are transmitted to temporary aggregation database 27 housed on multi-city query server 20. City pair report objects 19a, 19b, and 19c are sorted and filtered by cost processor 40 and sort and filter processor 35 to create multi-destination comparison report object 29, which is processed and configured by multi-city query server 20 to be displayed as a multi-destination comparison report on updated user interface 10.

What is claimed is:

1. A computer apparatus comprised of:
at least one user interface with a plurality of fields adapted to receive at least one destination criteria for creating a quasi-unique user query record object;
at least one city information database including a plurality of city data attributes, each of said city data attributes corresponding to at least one city and said at least one destination criteria;
at least one hardware processing component configured with software to perform at least one multi-criteria correlation;
at least one temporary database to store the results of said at least one multi-criteria correlation;
at least one hardware component to create at least one city pair object;
at least one rate provider database which is configured to receive said at least one city pair object and to produce at least one city pair report object containing rate information; and
at least one hardware processing component configured with software to display data from said city pair report object in a multi-destination comparison report.

2. The apparatus of claim 1 wherein said multi-destination comparison report includes real time results which are dynamically updated.

3. The apparatus of claim 1 wherein said multi-destination comparison report is a document.

4. The apparatus of claim 1 wherein said multi-destination comparison report is an updated user interface.

5. The apparatus of claim 1 wherein said multi-criteria correlation is a recursive search which successively searches said city information database using destination criteria specified in said user query record object.

6. The apparatus of claim 1 wherein said multi-criteria correlation is recursively performed using destination criteria which are ranked by priority.

7. The apparatus of claim 1 which further includes a hardware processing component for sorting said city pair report objects by ranking a data attribute of each of said city pair report objects to create a multi-destination comparison report sorted by said data attribute.

8. The apparatus of claim 1 wherein said rate information database is a database administered by a third party provider of rate information.

9. The apparatus of claim 1 which further includes a hardware processing component for filtering said city pair report objects using filtering criteria and algorithms.

10. The apparatus of claim 1 wherein said destination criteria and multi-criteria correlation are specified by an administrator.

11. The apparatus of claim 1 wherein said city information databases are geographically dispersed.

12. The apparatus of claim 1 wherein said city information databases are dynamically updated.

13. The apparatus of claim 1 which further includes a database of promotional terms which are used in performing said multi-criteria correlation to modify said city pair object.

14. The apparatus of claim 9 which further includes a database of promotional terms which are used as filtering criteria by said hardware processing component for filtering said city pair results record object.

15. The apparatus of claim 1 wherein said destination criteria includes attributes selected from a group consisting of budget, cost, geographic region, ethnicity, religion, historic temperature, projected temperature, weather conditions, sport activities, customer demographics, market demographics, business climate, business related characteristics, medical capabilities, family oriented activities, cultural activities, music activities, medical tourism, food, dietary restrictions, adult entertainment activities, culinary characteristics, alcohol production and consumption characteristics, rehabilitation services, substance abuse services, weight loss services, education, scholastic, festivals, hobby related activities, pet related criteria, animal specific criterion, cultural interests, exercise, fetish, air quality, investment potential, favorable legal environments, popular film and film festival destinations, popular film locations, space destinations, destinations in space, cruise destinations, water specific activities, air shows, jungle, forest and nature destinations, camping destinations, conferences, retreats, weddings, ecological tourism destinations, archeological destinations, crime destinations, beverage centric destinations, industrial destinations, commodities, language, male to female ratio, safety, political alignment and human rights record and combinations thereof.

16. The apparatus of claim 9 wherein said filtering criteria includes attributes selected from a group consisting of weather, weather-related factors, such as a UV-index or pollution levels, natural disasters, political unrest, protests, war, security alerts, epidemics, fuel shortages and combinations thereof.

17. A method for producing a multi-destination comparison report comprised of the steps of:
receiving at least one destination criterion;
forming at least one user query record object;
correlating said at least one user query record object with at least one city data attribute;
forming a quasi-unique city list;
forming at least one city data record object;
querying at least one rate supplier database;
forming at least one city response record object;
processing said at least one city response record object using a sort and filter processor;
creating a multi-destination comparison report object; and
displaying said multi-destination comparison report object.

18. The method of claim 17 which further includes the step of sorting said at least one city response record object based on prioritized destination criteria.

19. The method of claim 17 which further includes the step of updating said sort and filter processor with administrator specified criteria.

20. A destination suggestion system comprised of:
at least one user interface with a plurality of fields adapted to receive at least one destination criteria for creating a quasi-unique user query record object;
at least one city information database including a plurality of city data attributes, each of said city data attributes corresponding to at least one city and said at least one destination criteria;
at least one hardware processing component configured with software to perform at least one multi-criteria correlation;
at least one temporary database to store the results of said at least one multi-criteria correlation;
at least one hardware component to create at least one city pair object;
at least one third party rate provider database which is configured to receive said at least one city pair object and to produce at least one city pair report object containing rate information; and
at least one hardware processing component configured with software to display data from said city pair report object in a multi-destination comparison report.

21. The system of claim 20 wherein said multi-destination comparison report includes real time results which are dynamically updated.

22. The system of claim 20 wherein said multi-destination comparison report is a document.

23. The system of claim 20 wherein said multi-destination comparison report is an updated user interface.

24. The system of claim 20 wherein said multi-criteria correlation is a recursive search which successively searches said city information database using destination criteria specified in said user query record object.

25. The system of claim 20 wherein said multi-criteria correlation is recursively performed using destination criteria which are ranked by priority.

26. The system of claim 20 which further includes a hardware processing component for sorting said city pair report objects by ranking a data attribute of each of said city pair report objects to create a multi-destination comparison report sorted by said data attribute.

27. The system of claim 20 which further includes a hardware processing component for filtering said city pair report objects using filtering criteria and algorithms.

28. The system of claim 20 wherein said destination criteria and multi-criteria correlation are specified by an administrator.

29. The system of claim 20 wherein said city information databases are geographically dispersed.

30. The system of claim 20 wherein said city information databases are dynamically updated.

31. The system of claim 20 which further includes a database of promotional terms which are used in performing said multi-criteria correlation to modify said city pair object.

32. The system of claim 20 which further includes a database of promotional terms which are used as filtering criteria by said hardware processing component for filtering said city pair results record object.

33. The system of claim 20 wherein said destination criteria includes attributes selected from a group consisting of budget, cost, geographic region, ethnicity, religion, historic temperature, projected temperature, weather conditions, sport activities, customer demographics, market demographics, business climate, business related characteristics, medical capabilities, family oriented activities, cultural activities, music activities, medical tourism, food, dietary restrictions, adult entertainment activities, culinary characteristics, alcohol production and consumption characteristics, rehabilitation services, substance abuse services, weight loss services, education, scholastic, festivals, hobby related activities, pet related criteria, animal specific criterion, cultural interests, exercise, fetish, air quality, investment potential, favorable legal environments, popular film and film festival destinations, popular film locations, space destinations, destinations in space, cruise destinations, water specific activities, air shows, jungle, forest and nature destinations, camping destinations, conferences, retreats, weddings, ecological tourism destinations, archeological destinations, crime destinations, beverage centric destinations, industrial destinations, commodities, language, male to female ratio, safety, political alignment and human rights record and combinations thereof.

34. The system of claim 20 wherein said filtering criteria includes attributes selected from a group consisting of weather, weather-related factors, such as a UV-index or pollution levels, natural disasters, political unrest, protests, war, security alerts, epidemics, fuel shortages and combinations thereof.
